(19) United States
(12) Patent Application Publication
(10) Pub. No.: US 2024/0228682 A1
(43) Pub. Date: Jul. 11, 2024

(54) POLYETHYLENE COPOLYMER WITH BROAD SHORT CHAIN BRANCHING DISTRIBUTION

(71) Applicant: W.R. Grace & Co.-Conn., Columbia, MD (US)

(72) Inventors: Vivek KALIHARI, Clarksville, MD (US); John H. HAIN, Woodstock, MD (US); Jing ZHONG, Columbia, MD (US); C. Gail BLAKLEY, Baton Rouge, LA (US); Matthew G. THORN, Baton Rouge, LA (US)

(73) Assignee: W.R. Grace & Co.-Conn., Columbia, MD (US)

(21) Appl. No.: 18/560,378

(22) PCT Filed: May 13, 2022
(86) PCT No.: PCT/US2022/029208

§ 371 Date: Nov. 10, 2023

Related U.S. Application Data
(60) Provisional application No. 63/188,027, filed on May 13, 2021.

(51) Int. Cl. C08F 210/16; C08J 5/18; C08K 3/08

(52) U.S. Cl. CPC C08F 210/16; C08J 5/18; C08K 3/08; C08J 2323/06

(57) ABSTRACT

A polyethylene copolymer comprising ethylene units and C4 to C8 α-olefin comonomer units having the following characteristics: a melt index from about 0.1 to about 15 g/10 min as determined at 190° C. by ASTM D1238 under 2.16 kg and at 190° C.; a density from 0.905 to 0.930 g/cc; a molecular weight distribution from about 1.5 to about 2.7; a Crystallization Elution Fractionation temperature range excluding the first 10% and the last 1% polymer on the temperature scale following the equation: ΔT[° C.]≥−909*(density[g/cc])+863; and a lamellar thickness distribution following the equation: F %≥510*(density[g/cc]−0.905), where F % is the percentage of lamellar thickness greater than 12 nm.

### CROSS-REFERENCE TO RELATED APPLICATIONS

This application claims the benefit of priority to U.S. Provisional Patent Application No. 63/188,027, filed on May 13, 2021, the contents of which are incorporated herein by reference in their entirety.

### BACKGROUND

Polyethylene is an olefin polymer with many different end use applications. One type of polyethylene particularly useful for making films is linear low-density polyethylene (LLDPE), which is formed by copolymerizing ethylene with other olefin monomers such that the copolymer includes a polyethylene backbone with short branches extending therefrom. The distribution of the branches strongly influences the properties of the resulting polymer and its desirability for certain applications, such as forming packaging films. Examples of such properties include dart impact strength, tear resistance, heat seal initiation, hot tack initiation, optics, and processability. However, the improvement of some of these properties often causes others to be less desirable.

Metallocene catalyzed LLDPE (mLLDPE) polymers tend to have a short-chain branching distribution that is relatively uniform, or narrow, resulting in a polymer that has some good characteristics and some undesirable characteristics, such as having high toughness but bad processability and optics. Therefore, it is desirable to produce polyethylene polymers with more diversity in their branching, or a broader short-chain branching distribution, which can lead to further improvements in toughness without sacrificing processability and optics. Although attempts to form mLLDPE polymers having a broad short-chain branching distribution have been made, such as by using a mix of different catalysts or a series of reactors with different conditions, further improvements are needed.

### SUMMARY

The present disclosure is generally directed to a polyethylene comprising ethylene units and α-olefin comonomer units. The polyethylene has the following characteristics: a melt index from about 0.1 to about 15 g/10 min as determined by ASTM

D1238 under 2.16 kg and at 190° C.; a density from 0.905 to 0.930 g/ml as determined by ASTM D1505; a molecular weight distribution (Mw/Mn) from about 1.5 to about 2.7; a Crystallization Elution Fractionation temperature range excluding the first 10% and the last 1% polymer on the temperature scale following the equation: ΔT[° C.]≥−909*density[g/cc]+863; and a lamellar thickness distribution following the equation: F %≥510*(d[g/cc]−0.905), where F % is the percentage of lamellar thickness greater than 12 nm.

The present disclosure also provides a polyethylene comprising ethylene units and α-olefin comonomer units having the following characteristics: a melt index from about 0.1 to about 15 g/10 min as determined by ASTM D1238 under 2.16 kg and at 190° C.; a density from 0.905 to 0.935 g/ml as determined by ASTM D1505; a molecular weight distribution (Mw/Mn) from about 1.5 to about 2.7; a Crystallization Elution Fractionation temperature range excluding the first 10% and the last 1% polymer on the temperature scale following the equation: ΔT[° C.]≥−909*density[g/cc]+863; and a lamellar thickness distribution following the equation: F %≥510*(d[g/cc]−0.905), where F % is the percentage of lamellar thickness greater than 12 nm. The copolymer is polymerized in the presence of a catalyst composition comprising: (I) an intermediate composition derived from at least (a) a support, (b) an organoaluminum compound, and (c) an oxygen source; (II) either (A) R²₂AlY, wherein each R² independently comprises a hydrocarbyl group having from 1 to about 20 carbons, and Y comprises a halide radical, a pseudo halide radical, an alkoxide radical, an aryloxide radical, an alkyl substituted amide radical, an aryl substituted amide radical, a siloxy radical, a boronoxy radical, a diaryl boronoxy radical, or a halogenated diaryl boronoxy radical, or (B) a combination of (i) and (ii) wherein (i) is a compound having the formula R¹(X)ₙ; wherein R¹ is a hydrocarbyl group having from about 1 to about 20 carbon atoms; n is from 1 to the number of possible substitutions of the hydrocarbyl group and each X is optionally substituted on R¹ and is independently halogen, —OSi(R³)₃, —N(Si(R³)₃)₂, —N(R³)₂; —SR³; —P(R³)₂; —CN, or —OR⁴; wherein each R³ is independently hydrogen or a hydrocarbyl group having from about 1 to about 20 carbon atoms; each R⁴ is independently a hydrocarbyl having from 1 to 20 carbon atoms, wherein when at least one R³ is a hydrocarbyl group, R¹ and R³ or R¹ and R⁴ are optionally linked together to form a cyclic group; provided that at least one X is not directly bonded to an aryl group; and provided that when X is not halogen, X is bonded to a secondary or tertiary carbon, or a —CH₂-aryl group; and (ii) is a trihydrocarbylaluminum compound having the formula AlR₃, wherein each R is independently a C₁-C₂₀ hydrocarbyl group; and (III) a transition metal component.

Other features and aspects of the present disclosure are discussed in greater detail below.

### BRIEF DESCRIPTION OF THE DRAWINGS

The present disclosure may be better understood with reference to the following figures:

FIG. 1 is a CEF profile of the polyethylene copolymer produced in Example 2.

FIG. 2 is a chart with the cumulative CEF curve of the polyethylene copolymer produced in Example 2 overlayed on the m-SSA curve of the polyethylene copolymer produced in Example 2.

### DETAILED DESCRIPTION

Before describing several exemplary embodiments, it is to be understood that the invention is not limited to the details of construction or process steps set forth in the following description. The invention is capable of other embodiments and of being practiced or being carried out in various ways.

In general, the present disclosure is directed to a polyethylene having a broad short-chain branching distribution that possesses a unique blend of characteristics. A method for producing the polyethylene is also disclosed. As a result of its chemical composition distribution, the polyethylene has characteristics particularly beneficial for forming films. For example, films formed from the polyethylene polymer have good dart impact strength and tear resistance and low heat seal initiation and hot tack initiation without sacrificing optics and processability.

### 1) Polyethylene Copolymer

Polyethylene polymers according to the present disclosure are generally copolymers comprised of ethylene-based units and α-olefin-based comonomer units, such as C4-C8 α-olefin-based comonomer units. The copolymers can include more than one comonomer species, such as a combination of 1-hexene and 1-octene. As such, the term copolymer is not limited to a polymer containing only two monomer species. The comonomer content is typically from about 0.5 mol % to about 4 mol %. Preferably, the comonomer comprises 1-hexene.

The density of the polyethylene copolymer is generally from about 0.905 g/cc to about 0.935 g/cc. For example, the density is preferably greater than about 0.910 g/cc, such as greater than about 0.915 g/cc. Additionally, the density is preferably less than about 0.930 g/cc, such as less than about 0.925 g/cc, such as less than about 0.920 g/cc. The melt index of the copolymer is generally from about 0.1 g/10 min to about 15 g/10 min when measured according to ASTM D1238 (2.16 kg, 190° C.). For example, the melt index is preferably greater than about 0.25 g/10 min, such as greater than about 0.5 g/10 min, such as greater than about 0.75 g/10 min, such as greater than about 0.9 g/10 min when measured according to ASTM D1238 (2.16 kg, 190° C.). Additionally, the melt index is preferably less than about 10 g/10 min, such as less than about 5 g/10 min, such as less than about 2.5 g/10 min when measured according to ASTM D1238 (2.16 kg, 190° C.). The molecular weight distribution MWD (Mw/Mn) is typically from about 1.5 to about 2.7.

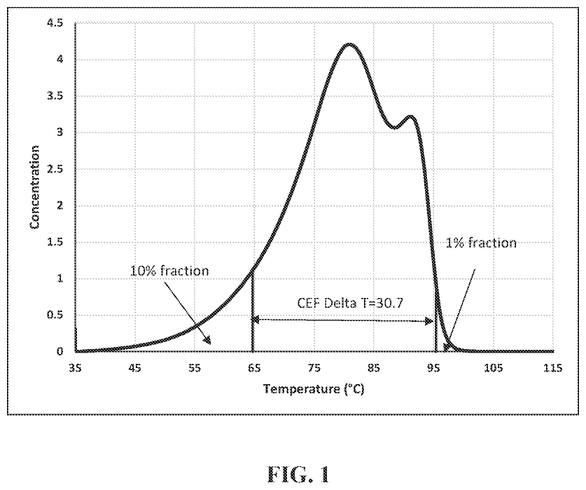

The polyethylene copolymer has a broad short-chain branching distribution for a metallocene-catalyzed LLDPE. One method of measuring short-chain branching distribution is by analyzing the polymer's crystallization elution fractionation (CEF) profile and/or its successive self-nucleation and annealing (SSA) profile. The breadth of the CEF profile can be quantified by measuring the difference (ΔT) between the temperature at which 10% of the area underneath the elution profile falls below and the temperature at which 1% of the area underneath the elution profile falls above. FIG. 1 illustrates a CEF profile including the ΔT for a polyethylene copolymer in accordance with the present disclosure. This temperature difference is generally larger for copolymers with a broader short-chain branching distribution. The polyethylene copolymer described herein generally has a short-chain branching distribution such that ΔT[° C.]≥−909*(density[g/cc])+863. For example, ΔT is preferably greater than about 13° C., such as greater than about 15° C., such as greater than about 20° C., such as greater than about 25° C., such as greater than about 30° C. Generally, the polyethylene copolymer has a short-chain branching distribution such that ΔT[° C.]≤−909*(density[g/cc])+873. For example, ΔT is preferably less than about 50° C., such as less than about 45° C., such as less than about 40° C., such as less than about 35° C.

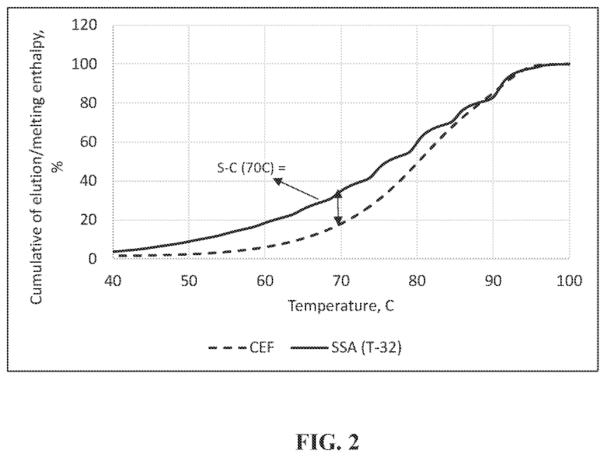

Additionally, the copolymer may be characterized by the percentage difference (S−C) between the point on the cumulative CEF curve at a specified temperature and the point on the modified cumulative SSA curve at that same temperature. The modified cumulative SSA curve (m-SSA) refers to the cumulative SSA curve minus 32° C., which allows for a better comparison with the cumulative CEF curve. FIG. 2 illustrates a cumulative m-SSA curve for a polyethylene copolymer in accordance with the present disclosure with the corresponding cumulative CEF curve overlayed on it. The S−C percentage difference at 70° C. is illustrated as well. In general, the polyethylene copolymer has an S−C at 70° C. of less than about 15%, preferably less than about 14%. The S−C at 70° C. is typically greater than about 6%, such as greater than about 10%.

The polyethylene copolymer is further characterized by its lamellar thickness distribution, which can be obtained from its SSA curve and the following well-known equation:

$${L}_{c} = \frac{0.62 - 414.2}{414.2 - {T}_{m}} ,$$

where L_{c} is the lamellar thickness in nm for a given melting point, Tₘ(K). In general, the polyethylene copolymer has a lamellar thickness distribution following the equation: F %≥510*(d[g/cc]−0.905), where F % is the percentage of lamellar thickness greater than 12 nm, and d is density in g/cc. Preferably, the polyethylene copolymer has a lamellar thickness distribution following the equation: F %≥600*(d[g/cc]−0.905), such as wherein the percentage of lamellar thickness greater than 12 nm follows the equation: F %≥700*(d[g/cc]−0.905), such as wherein the percentage of lamellar thickness greater than 12 nm follows the equation: F %≥770*(d[g/cc]−0.905). Typically, the polyethylene copolymer has a lamellar thickness distribution following the equation: F % ≤510*(d[g/cc]−0.905)+40.

### 2) Process for Making the Polyethylene Copolymer

The polyethylene copolymer is produced using particular combinations of activators and transition metal catalyst components. For example, the present inventors discovered that certain supported activator compositions, when used with certain metallocene catalysts in ethylene polymerization processes, afford the unique resin properties described herein. Advantageously, the catalysts described herein also leave significantly lower catalyst residue in the polymer resin compared to prior catalysts, as a result of higher catalytic activity. For example, pellets produced from the polyethylene copolymer generally contain a transition metal component, such as Zr, in an amount less than 0.5 ppm. Preferably, the polyethylene copolymer contains a transition metal component, such as Zr, in an amount less than 0.45 ppm, such as less than 0.4 ppm, such as less than about 0.35 ppm. Pellets containing the copolymer typically contain a transition metal component in an amount of at least about 10 ppm, such as at least about 20 ppm, such as at least about 25 ppm.

One advantage of the process disclosed herein is that the polyethylene can be produced using only a single reactor, rather than in a series of two or more reactors. Additionally, the polyethylene can be polymerized using a single species of catalyst, rather than using a mix of different catalysts. The ability to use a single catalyst species in a single reactor allows for a more efficient production process than other attempts to make mLLDPEs with broad short chain branching distributions.

The activator compositions particularly useful in producing the polyethylene copolymer are described in U.S. Pat. Nos. 8,354,485 and 9,090,720, which are both incorporated by reference herein. For example, the activator composition generally comprises (I) an intermediate composition derived from at least (a) a support, (b) an organoaluminum compound, and (c) an oxygen source; and (II) either (A) R²₂AlY, wherein each R² independently comprises a hydrocarbyl group having from 1 to about 20 carbons, and Y comprises a halide radical, a pseudo halide radical, an alkoxide radical, an aryloxide radical, an alkyl substituted amide radical, an aryl substituted amide radical, a siloxy radical, a boronoxy radical, a diaryl boronoxy radical, or a halogenated diaryl boronoxy radical; or (B) a combination of (i) and (ii) wherein (i) is a compound having the formula R¹(X)ₙ; wherein R¹ is a hydrocarbyl group having from about 1 to about 20 carbon atoms; n is from 1 to the number of possible substitutions of the hydrocarbyl group and each X is optionally substituted on R¹ and is independently halogen, —OSi(R³)₃, —N(Si(R³)₃)₂, —N(R³)₂; —SR³; —P(R³)₂; —CN, or —OR⁴; wherein each R³ is independently hydrogen or a hydrocarbyl group having from about 1 to about 20 carbon atoms; each R⁴ is independently a hydrocarbyl having from 1 to 20 carbon atoms; wherein when at least one R³ is a hydrocarbyl group, R¹ and R³ or R¹ and R⁴ are optionally linked together to form a cyclic group; provided that at least one X is not directly bonded to an aryl group, and provided that when X is not halogen, X is bonded to a secondary or tertiary carbon, or a —CH₂-aryl group and (ii) is a trihydrocarbylaluminum compound having the formula AlR₃, wherein each R is independently a C₁-C₂₀ hydrocarbyl group.

### I. Intermediate Composition

The intermediate composition can be formed by combining at least a support, an organoaluminum compound, and an oxygen source. The oxygen source can be any source of an oxygen atom, such as O₂ or H₂O, including water that is contained in the support. The order of addition when combining the components is interchangeable. For example, the order of addition may be [(support+oxygen source)+organoaluminum compound], or it may be [(organoaluminum compound+oxygen source)+support]. In addition, an oxygenated organoaluminum compound, such as MAO, can be combined with a support. As used herein, an oxygenated organoaluminum compound is a compound that has been derived from at least an organoaluminum compound and an oxygen source. The purpose of forming this intermediate composition is to generate Lewis acid sites (i.e., sites suitable for accepting at least one electron pair) to react with the dialkylaluminum cation precursor agent to generate dialkylaluminum cation precursors on the supports/supports. The raw material of the support can contain absorbed water, which can serve as the source of oxygen. A second source of oxygen then becomes optional. The support containing water can then be combined with an organoaluminum compound, for example, trimethylaluminum (TMA), to form the intermediate composition. The support can be dried first to eliminate absorbed water and then a predetermined amount of water can be added back to the support for more precise control of the water content. The oxygen source can be combined with the organoaluminum compound to form a first product (e.g., MAO formed from water and TMA or from Ph₃COH and TMA), followed by forming a second product (composition derived from support and oxygenated organoaluminum compound) by combining the first product with a dried or non-dried support.

### a) Support

Supports useful in the activator composition can comprise inorganic supports or organic supports. Such supports may contain water, or water may be removed from the supports by any means known in the art, such as by calcining. Also, such supports may be those in which a predetermined amount of water has been added after the absorbed water is completely or incompletely eliminated therefrom. Such supports can contain up to a percentage of water such that free water is not leaching out of the support. Supports containing water can be either non-calcined or low-temperature calcined. As used herein, a “non-calcined” support is a support that has not purposely been subjected to calcining treatment, and a “low-temperature calcined” support is a support that has been calcined at a temperature less than 200° C., such as less than about 100° C., such as less than about 50° C. The calcination may be performed in any atmosphere, for example, in an atmosphere of air, an inert gas, or under a vacuum.

A plurality of supports can be used as a mixture, and the supports may comprise water as absorbed water or in hydrate form. The supports are preferably porous and have a total pore volume of not less than 0.1 ml/g of support, such as not less than 0.3 ml/g of support. The average particle diameter of the support may be from about 5 micrometers to about 1000 micrometers, such as from about 10 micrometers to about 500 micrometers.

Useful inorganic supports include inorganic oxides, magnesium compounds, clay minerals and the like. The inorganic oxides can comprise silica, alumina, silica-alumina, magnesia, titania, zirconia, and clays. Useful inorganic oxides include, without limitation, SiO₂, Al₂O₃, MgO, ZrO₂, TiO₂, B₂O₃, CaO, ZnO, BaO, ThO₂ and double oxides thereof, e.g. SiO₂—Al₂O₃, SiO₂—MgO, SiO₂—iO₂, SiO₂—TiO₂—MgO. Useful magnesium compounds include MgCl₂, MgCl(OEt) and the like. Useful clay minerals include kaolin, bentonite, kibushi clay, geyloam clay, allophane, hisingerite, pyrophylite, talc, micas, montmorillonites, vermiculite, chlorites, palygorskite, kaolinite, nacrite, dickite, halloysite and the like.

In one embodiment, a suitable silica support is porous and has a surface area in the range of from about 10 m²/g silica to about 1000 m²/g silica, such as from about 10 m²/g silica to about 700 m²/g silica, a total pore volume in the range of from about 0.1 ml/g silica to about 4.0 ml/g silica, and an average particle diameter in the range of from about 10 micrometers to about 500 micrometers. Suitable silicas preferably have a surface area in the range of from about 50 m²/g to about 500 m²/g, a pore volume in the range of from about 0.5 ml/g to about 3.5 ml/g, and an average particle diameter in the range of from about 15 micrometers to about 150 micrometers.

The average pore diameter of a useful porous silica support is typically in the range of from about 10 angstroms to about 1000 angstroms, such as from about 50 angstroms to about 500 angstroms, such as from about 175 angstroms to about 350 angstroms. A typical content of hydroxyl groups is from about 2 mmol OH/g silica to about 10 mmol OH/g silica, such as from about 3 mmol OH/g silica to about 8 mmol OH/g silica, such as from about 3.3 mmol OH/g silica to about 7.2 mmol OH/g silica.

Useful organic supports include acrylic polymers, styrene polymers, ethylene polymers, propylene polymers and the like. The acrylic polymers can include polymers of acrylic monomers such as acrylonitrile, methyl acrylate, methyl methacrylate, methacrylonitrile and the like, and copolymers of the monomers and crosslinking polymerizable compounds having at least two unsaturated bonds. The styrene polymers can include polymers of styrene monomers such as styrene, vinyltoluene, ethylvinylbenzene and the like, and copolymers of the monomers and crosslinking polymerizable compounds having at least two unsaturated bonds. Crosslinking polymerizable compounds having at least two unsaturated bonds can include divinylbenzene, trivinylbenzene, divinyltoluene, divinylketone, diallyl phthalate, diallyl maleate, N,N′-methylenebisacrylamide, ethylene glycol dimethacrylate, polyethylene glycol dimethacrylate and the like.

Useful organic supports generally have at least one polar functional group. Suitable polar functional groups include primary amino groups, secondary amino groups, imino groups, amide groups, imide groups, hydrazide groups, amidino groups, hydroxyl groups, hydroperoxy-groups, carboxyl groups, formyl groups, methyloxycarbonyl groups, carbamoyl groups, sulfo groups, sulfino groups, sulfeno groups, thiol groups, thiocarboxyl groups, thioformyl groups, pyrrolyl groups, imidazolyl groups, piperidyl groups, indazolyl groups and carbazolyl groups. When the organic support originally has at least one polar functional group, the organic support can be used as it is. One or more kinds of polar functional groups can also be introduced by subjecting the organic support to a suitable chemical treatment. The chemical treatment may be any method capable of introducing one or more polar functional groups into the organic support. For example, it may be a reaction between acrylic polymer and polyalkylenepolyamine such as ethylenediamine, propanediamine, diethylenetriamine, tetraethylenepentamine, dipropylenetriamine or the like. For example, an acrylic polymer (e.g. polyacrylonitrile) may be treated in a slurry state in a mixed solution of ethylenediamine and water at 100° C. or more. The amount of polar functional group in the organic support having a polar functional group may be from 0.01 to 50 mmol/g, or from 0.1 to 20 mmol/g.

### b) Organoaluminum Compound

Useful organoaluminum compounds can comprise AlRₙ(XR¹ₘ)₍₃₋ₙ₎ wherein Al is aluminum; each R is hydrogen or a hydrocarbyl group having up to about 20 carbon atoms, and each R may be the same as, or different from, any other R; for each XR¹, X is a hetero atom and R¹ is an organic group bonded to the Al through the hetero atom and having up to about 20 carbon atoms; each XR¹ may be the same as, or different from, any other XR¹; and n is 1, 2, or 3. When X is halide, m=0; when X is O or S, m=1; when X is N or P, m=2. Each R can be a straight-chain or branched alkyl group. Non-limiting examples of R include alkyl groups having from 1 to about 10 carbon atoms such as methyl, ethyl, n-propyl, isopropyl, n-butyl, isobutyl, n-pentyl, neopentyl and the like.

Non-limiting examples of AlRₙ(XR¹ₘ)₍₃₋ₙ₎ include, for compounds with n=3: trimethylaluminum, triethylaluminum, triisobutylaluminum, trioctylaluminum, diisobutylaluminum hydride, diethylaluminum hydride, dimethylaluminum hydride; for compounds with n=1 or 2 and m=0: AlMe₂Cl, AlMeCl₂, AlMe2F, AlMeF₂; for compounds with n=1 or 2 and m=1: (2,6-di-tert-butyl-4-methylphenoxy)diisobutylaluminum, bis(2,6-di-tert-butyl-4-methylphenoxy)isobutylaluminum, (2,6-di-tert-butyl-4-methylphenoxy)diethylaluminum, bis(2,6-di-tert-butyl-4-methylphenoxy)ethylaluminum, (2,6-di-tert-butyl-4-methylphenoxy)dimethylaluminum, bis(2,6-di-tert-butyl-4-methylphenoxy)methylaluminum, AlMe₂(O^{t}Bu), AlMe(O^{t}Bu)₂, AlMe₂(OCPh₃), AlMe(OCPh₃)₂; for compounds with n=1 or 2 and m=2: AlMe₂(NMe₂), AlMe(NMe₂)₂, AlMe₂(NEt₂), AlMe(NEt₂)₂, AlEt₂(NMe₂), AlEt(NMe₂)₂, AlEt₂(NEt₂), AlEt(NEt₂)₂, AlⁱBu₂(NMe₂), AlⁱBu (NMe₂)₂, AlᵢBu₂(NEt₂), AlⁱBu (NEt₂)₂, AlMe₂(N(SiMe₃)₂), AlMe(N(SiMe₃)₂)₂; and mixtures thereof.

The organoaluminum compounds can be prepared by any suitable method, including currently known methods, as will be familiar to those skilled in the art, or methods that may come to be known.

### c) Oxygen Source

The oxygen source can be any source of an oxygen atom, e.g., water in the support. Alternatively, the oxygen source can be any suitable oxygen source, as will be familiar to those skilled in the art given the teaching of this specification. Examples include but are not limited to 1) free water in either the gas phase or the condensed phase (liquid or solid), 2) a coordinated form of water such as hydrated metal salts (e.g., LiOH(H₂O)ₙ), and 3) water absorbed on compounds containing hydroxy groups, molecular sieves, and the like. Additionally, the oxygen source can be hydroxy- or carbonyl-containing compounds in which the oxygen atom is directly linked to either a tertiary carbon and a hydrogen, for example, ^{t}BUOH, Ph₃COH, and the like, or a tertiary carbon and an Al after reacting with a trialkylaluminum, for example, PhCOMe, PhCOOH, and the like. Depending on the organoaluminum compound in use, the amount of oxygen source can be adjusted so that each of a majority (at least about 50 mol %) of the oxygen atoms therein contacts at least two aluminum atoms. The Al:O mol ratio can be from about 100:1 to about 1:1.2, or can be a ratio such that the amount of hydroxy or alkoxy residue does not significantly interact with the active catalyst species generated during methods of this invention.

### Dialkylaluminum Cation Precursor Agents (II-A)

Useful dialkylaluminum cation precursor agents include R²₂AlY, wherein each R² independently comprises a hydrocarbyl group having up to about 20 carbon atoms, Al is aluminum, and Y comprises a hetero atom or group bonded to the Al. Each hydrocarbyl group can comprise one or more heteroatom substituted groups, although this is not required. Y can comprise, for example, a hetero atom such as O, N, etc., or a group such as halide radical, pseudo halide radical, alkoxide radical, aryloxide radical, alkyl substituted amide radical, aryl substituted amide radical, siloxy radical, boronoxy radical, diaryl boronoxy radical, halogenated diaryl boronoxy radical, and the like.

For example, the dialkylaluminum cation precursor agent may comprise dimethylaluminum fluoride (Me₂AlF), dimethylaluminum chloride, diethylaluminum fluoride, diethylaluminum chloride, di-n-propylaluminum fluoride, diisobutylaluminum chloride, di-n-butylaluminumchloride, diisobutylaluminum fluoride, di-n-hexylaluminum chloride, dimethylaluminum methoxide, dimethylaluminum ethoxide, dimethylaluminum isobutoxide, dimethylaluminum phenoxide, dimethylaluminum pentafluorophenoxide (Me₂Al(OC₆F₅)), dimethylaluminum (2,6-di-t-butyl-4-methyl)phenoxide (Me₂Al(BHT)), dimethylaluminum (2,6-di-isobutyl)phenoxide, dimethylaluminum dimethylamide, dimethylaluminum diethylamide, dimethylaluminum dibutylamide, dimethylaluminum methylphenylamide, diethylaluminum methoxide, diethylaluminum ethoxide, diethylaluminum isobutoxide, diethylaluminum phenoxide, diethylaluminum pentafluorophenoxide, diethylaluminum (2,6-di-t-butyl-4-methyl)phenoxide, diethylaluminum (2,6-di-isobutyl)phenoxide, diethylaluminum dimethylamide, diethylaluminum diethylamide, diethylaluminum dibutylamide, diethylaluminum methylphenylamide, diisobutylaluminum methoxide, diisobutylaluminum ethoxide, diisobutylaluminum methoxide, diisobutylaluminum phenoxide, diisobutylaluminum pentafluorophenoxide, diisobutylaluminum (2,6-di-t-butyl-4-methyl)phenoxide, diisobutylaluminum (2,6-di-isobutyl)phenoxide, diisobutylaluminum dimethylamide, diisobutylaluminum diethylamide, diisobutylaluminum dibutylamide, and/or diisobutylaluminum methylphenylamide.

A dialkylaluminum cation precursor agent can also be generated in-situ by mixing AlR²₃ (e.g., AlMe₃) with AlR²Y₂ (e.g., AlMeF₂) or AlY₃ (e.g., AlF₃). The AlR²₃ can be combined with an intermediate composition derived from at least an organoaluminum compound, a support, and an oxygen source, or can be coordinated with or a part of the MAO framework.

A Lewis base component is optional. When included, the Lewis base can be chelating or non-chelating. The Lewis base is a reagent that is able to donate at least one pair of electrons to form a stable dialkylaluminum cation complex derived from the dialkylaluminum cation precursor in the system, including N, O, or halide donors. For example, suitable Lewis bases include non-chelating Lewis bases such as PhNMe₂, PhNEt₂, PhNPr₂, Ph₂NMe, Ph₂Net, Ph₂NPr, NMe₃, NEt₃, Me₃SiOSiMe₃, EtOEt, THF (tetrahydrofuran), PhOMe, ^{t}BuOMe, ClPh, FPh, and the like and chelating Lewis bases such as Me₂N(CH₂)₂NMe₂, Et₂N(CH₂)₂NEt₂, Ph₂N(CH₂)₂NPh₂, Me₂N(CH₂)₃NMe₂, Et₂N(CH₂)₃NEt₂, Ph₂N(CH₂)₃NPh₂, Me₃SiOSi(Me)₂OSiMe₃ (OMTS), MeO(CH₂)₂OMe, EtO(CH₂)₂OEt, PhO(CH₂)₂OPh, MeO(CH₂)₃OMe, EtO(CH₂)₃OEt, Ph₂O(CH₂)OPh, and the like.

The activator compositions can be derived from at least a support, an oxygen source, an organoaluminum compound, and a dialkylaluminum cation precursor agent. The support can be combined with the organoaluminum compound and oxygen source to form an intermediate composition, and at least a portion of the intermediate composition can be combined with the dialkylaluminum cation precursor agent to form an activator composition. The oxygen source can be water that is already in the support. Also, the organoaluminum and oxygen source (e.g., water) can be precombined to form an oxygenated organoaluminum compound that is then combined with the support to form an intermediate composition.

The combining can be conducted in an inert gas atmosphere; at a temperature from about −80° C. to about 200° C., such as from about 0° C. to about 150° C.; and the combining time can be from about 1 minute to about 36 hours, such as from about 10 minutes to about 24 hours. Treatments after completion of the combining operation can include filtration of supernatant, followed by washing with inert solvent and evaporation of the solvent under reduced pressure or in inert gas flow, but these treatments are not required.

Resulting activator compositions can be used for polymerization in any suitable state, including fluid, dry, or semi-dry powder, and may be used for polymerization as a suspension in an inert solvent. The combining of the support, the oxygen source, and the organoaluminum compound can be conducted at ambient temperature and at a combining time of from about 15 minutes to about 48 hours, such as from about 15 minutes to about 6 hours; and the resulting combination can be used as is or can be subsequently heated to a temperature of about 80° C. to about 150° C. Alternatively, the combining of the support, oxygen source, and organoaluminum compound can be conducted at a temperature of from about 80° C. to about 150° C. at a combining time of from about 15 minutes to about 6 hours. At least a portion of resulting intermediate composition is combined with the dialkylaluminum cation precursor agent.

The amount of aluminum atom in the product, e.g., solid component, obtained by combining a low-temperature calcined support and a trialkylaluminum compound should be at least about 0.1 mmol aluminum atom, such as at least about 1 mmol aluminum atom, in 1 g of the solid component in the dry state.

The activator composition can be prepared by (i) combining a support containing water with the organoaluminum compound, then adding the dialkylaluminum cation precursor agent; (ii) combining MAO with a support, then adding the dialkylaluminum cation precursor agent; or (iii) combining a support with water, then adding the organoaluminum compound, then adding the dialkylaluminum cation precursor agent.

### Carbocation Precursor (II-B)

Alternatively, the activator composition can contain a combination of (i) a carbocation precursor R¹(X)ₙ and (ii) a trihydrocarbylaluminum compound.

A carbocation precursor is a compound containing at least one carbon atom directly linked to a labile electron rich leaving group X, which readily forms an ion-pair when brought in contact with a supported aluminoxane, with the leaving group X binding to the aluminoxane backbone to form the anion and the carbon directly linked to the leaving group X becoming a carbocation. Because a silicon atom has similar chemical properties to a carbon atom in terms of cation formation, although the derived silyl cation is less stable, the carbocation precursor also includes a silyl cation precursor that contains a silicon atom directly linked to a labile electron rich leaving group X, which readily forms an ion-pair containing a silyl cation when brought in contact with the aluminoxane. Compounds that may be used as a carbocation precursor are those having the formula R¹(X)ₙ; wherein each X may be anywhere on R¹ and is independently halogen (fluorine, chlorine, or bromine, preferably fluorine), —OSi(R³)₃, —N(Si(R³)₃)₂, —N(R³)₂; —SR³, —P(R³)₂, —CN, or —OR⁴; wherein each R³ is independently hydrogen or a hydrocarbyl group having from about 1 to about 20 carbon atoms; each R⁴ independently a hydrocarbyl having from 1 to 20 carbon atoms; wherein when at least one R³ is a hydrocarbyl group, R¹ and R³ or R¹ and R⁴ may be linked together to form a cyclic group; R¹ is a hydrocarbyl group having from about 1 (when X is halogen) or about 3 (when X is not halogen) to about 20 carbon atoms; n is from 1 to the number of possible substitutions of the hydrocarbyl group; provided that at least one X is not directly bonded to an aryl group, and provided that when X is not halogen, X is bonded to a secondary or tertiary carbon, or a —CH₂-aryl group on R¹.

The “aryl” proviso disclosed above is for the situation when the labile electron rich leaving group “X” is bounded directly to an aryl group. It has been observed that X in this situation is non-labile, i.e., such groups remain bound to the aryl group when brought into contact with the supported or non-supported aluminoxane and/or organoaluminum compounds. Preferably when R¹ comprises an aryl group, R¹ is an aralkyl group such that at least one X is bound to the alkyl group (i.e., aryl-alkyl-X, e.g., PhCH₂—X), thereby containing at least one labile leaving group. Also, the “secondary or tertiary carbon” proviso disclosed above is for situations when the labile electron rich leaving group “X” is not a halogen and bounded to a primary alkyl group. It has also been observed that X in this situation is non-labile, i.e., such groups remain bound to the primary alkyl group when brought into contact with the supported or non-supported aluminoxane and/or organoaluminum compounds. For example, when X contains oxygen and R¹ is a primary alkyl, such as diethyl ether (R1=Et and X=OEt) or tetrahydrofuran (THF) (R1═—CH₂CH₂—, and X═OR³ ═—OCH₂CH₂— and R¹ and R³ are linked to form a cyclic group), they remain as a solvent when mixing with a supported or non-supported MAO.

In one embodiment, n is 1, 2, 3, 4, 5 or 6. In another embodiment, R¹ is a C₁-C₈ alkyl or C₇-C₁₅ aralkyl. In another embodiment, X is —OR², and R² is a C₁-C₄ alkyl or C₆-C₁₅ aralkyl.

In one embodiment, R¹(X)ₙ is (R⁵)₃C—OR⁶ or (R⁵)₃C—N(R⁶)₂; wherein each R⁵ is independently a hydrogen or a hydrocarbyl group having from about to about 20 carbon atoms; R⁶ is a hydrocarbyl group having from about 1 to about 20 carbon atoms; or R⁵ and R⁶ may be linked together to form a cyclic group. Preferably, R⁵ is independently a C₁-C₁₈ group, and more preferably (R⁵)₃C is independently tert-butyl or trityl, and R⁶ a C₁-C₆ alky group.

When X is halogen in R¹(X)ₙ, R¹ can be a primary, secondary or tertiary hydrocarbyl group; and when X is a non-halogen group, R¹ is preferably a tertiary hydrocarbyl group or a saturated carbon separated aromatic group, and less preferably a secondary hydrocarbyl group, but not a primary hydrocarbyl group. The definitions of primary, secondary, and tertiary hydrocarbyl groups are as follows: a primary hydrocarbyl group represents a —CH₂R group (e.g., ethyl —CH₂CH₃ or propyl —CH₂CH₂CH₃), a secondary hydrocarbyl group represents a —CH(R)₂ group (e.g., isopropyl —CH(Me)₂ or sec-butyl —CH(Me)CH₂CH₃) and a tertiary hydrocarbyl group represents a —CR₃ group (e.g., tert-butyl —CMe₃ or trityl CPh₃), where R is a hydrocarbyl contains at least one carbon. A saturated carbon separated aromatic group is a —CH₂Ar group, where Ar is an aromatic group (e.g., benzyl-CH₂Ph),

Non-limiting examples of R₁(X)ₙ are: when X═F, fluoromethane CH₃F, fluoroethane CH₃CH₂F, tert-butyl fluoride Me₃CF, trityl fluoride Ph₃CF, trimethylsilylfluoride Me₃SiF, α-fluorotoluene C₆H₅CH₂F, α,α-difluorotoluene C₆H₅CHF₂, α, α, α-trifluorotoluene CF₃Ph, 1,3-bis(trifluoromethyl)benzene 1,3-(CF₃)₂Ph, and the like; when X═O, isopropylmethyl ether Me₂CHOMe, tert-butylmethyl ether Me₃COMe, tritylmethyl ether Ph₃COMe, butenoxide CH₂OCHCH₂CH₃, 1,2-di-tert-butylbenzene 1,2-(^{t}BuO)₂C₆H₄, 1,3-di-tert-butylbenezene, 1,3-(^{t}BuO)₂C₆H₄, 1,4-(^{t}BuO)₂c₆H₄; ^{t}BuO—CH₂—CH₂—O—^{t}Bu, isobutene oxide CH₂OCMe₂, 2,3-dimethoxyl-2,3-dimethylbutane Me₂C(OMe)C(OMe)Me₂, 2,3-dimethoxylbutane MeCH(OMe)CH(OMe)Me; tert-butyltrimethylsilyl ether Me₃COSiMe₃, 1-methyl-tetrahydrofuran, 1,2-dimethyl-tetrahydrofuran and the like, and when X═N, triisopropylamine (Me₂CH)₃N, tert-butyldimethyl amine Me₃CNMe₂, tritylmethyldimethyl amine Ph₃CNMe₂, 2,3-bis(dimethylamino)-2,3-dimethylbutane Me₂C(NMe₂)C(NMe₂)Me₂, 2,3-bis(dimethylamino)butane MeCH(NMe₂)CH(NMe₂)Me; tert-butyltrimethylsilyl ether Me₃COSiMe₃, N,N-dimethylbenzylamine and the like, and when X═O and N on a saturated carbon separated aromatic group, benzylmethyl ether MeOCH₂Ph, benzyldimethylamine Me₂NCH₂Ph and the like, wherein C₆H₄ is a phenylene group and ^{t}Bu is a tertiary-butyl group.

Non-limiting examples of R¹(X)ₙ are Me₃CF, Me₃SiF, C₆H₅CH₂F, C₆H₅CF₃1,3-C₆H₄(CF₃)₂, 1,2-(^{t}BuO)₂C₆H₄; 1,3-(^{t}BuO)₂C₆H₄, 1,4-(^{t}BuO)₂C₆H₄; ^{t}BuO—CH₂—CH₂O^{t}Bu; or mixtures thereof, wherein C₆H₄ is a phenylene group and ^{t}Bu is a tertiary-butyl group.

Other non-limiting examples of R¹(X)ₙ are tertiary-butyl methyl ether, tertiary-butyl ethyl ether, tertiary-butyl propyl ether, tertiary-butyl butyl ether, 1-tert-butoxy-2,6-di-tert-butylbenzene, 1-trimethylsiloxy-2,6-di-tert-butylbenzene, trimethylsiloxybenzene, trimethylmethoxysilane, benzylmethyl ether, benzyl ethyl ether, benzylpropyl ether, benzyl butyl ether or mixtures thereof.

Still other non-limiting examples of R¹(X)ₙ are propylene oxide, isobutene oxide, 1-butene oxide, styrene oxide, 4-methyl-styrene oxide, trimethylene oxide, 2,2-dimethyl-trimethylene oxide, 2,2-diphenyl-trimethylene oxide, 1-methyl-tetrahydrofuran, 1,1-dimethyl-tetrahydrofuran, 1-methyl-ethyleneimine, 1,1,2-trimethylethylenimine, 1,1-diphenyl-2-methyl-ethylenimine, 1-methyl-tetrahydro-pyrrole, 1,1-dimethyl-tetrahydro-pyrrole, 1,1-diphenyl-2-methyl-tetrahydro-pyrrole, 1-methyl-piperidine, 1,1-dimethyl-piperidine, 1,1-diphenyl-2-methyl-piperidine, or mixtures thereof.

Preferred examples of R¹(X)ₙ are: CF₃C₆H₅, isobutene oxide, and N,N-dimethylbenzylamine.

The trihydrocarbylalumimun compound generally has the formula AlR₃, wherein Al is aluminum and each R is independently a C₁-C₂₀ hydrocarbyl group. Non-limiting examples of R include alkyl groups having from 1 to about 10 carbon atoms such as methyl, ethyl, n-propyl, isopropyl, n-butyl, isobutyl, n-pentyl, neopentyl, benzyl, substituted benzyl and the like. Preferably, the trihydrocarbylaluminum compound is beta-proton free. Non-limiting examples of AlR₃ useful in this invention include, but is not limited to: trimethylaluminum, triethylaluminum, tripropylaluminum, tributyaluminum, triisobutylaluminum, tri-n-octylaluminum, trineopentylaluminum, tribenzylaluminum, tris(2,6-dimethylbenzyl)aluminum, or mixtures thereof, preferably, trimethylaluminum (AlMe₃), trineopentylaluminum (Al(CH₂C(Me₃)₃)₃), and tribenzylaluminum (Al(CH₂C₆H₅)₃).

Trihydrocarbylaluminum compounds of this invention can be prepared by any suitable method, including currently known methods, as will be familiar to those skilled in the art, or methods that may come to be known.

The supported activator composition can be prepared by combining the components in any order, but preferably, the trihydrocarbylaluminum is first combined with the supported aluminoxane intermediate and then the carbocation agent is introduced.

Preferably, the supported aluminoxane intermediate may be formed by adding an aluminoxane compound formed through the contact of the oxygen source and the organoaluminum compound to the support, such as contacting a calcined silica free of physically absorbed water with methylaluminoxane formed through the reaction of water and trimethylaluminum. The supported activator composition can then be formed by combining at least a portion of the supported aluminoxane intermediate with the trihydrocarbylaluminum compound and then the carbocation agent.

More preferably, the supported aluminoxane intermediate may be formed “in-situ” by adding an organoaluminum compound on the oxygen source containing support, such as water physically absorbed on silica. The supported activator composition of this invention can then be formed by combining at least a portion of the supported aluminoxane intermediate with the trihydrocarbylaluminum compound and then the carbocation agent. The oxygen source that originally exists on the support may be supplemented with additional oxygen sources to allow the reaction with more organoaluminum compound to increase the Al loadings on the supported aluminoxane intermediates. For example, a non-calcined silica with 5-6% water can be saturated with more water to reach 10-12% in order to increase the Al loadings from about 7% to about 14%. Another example is adding a desired amount of water to physically absorbed water free silica (e.g., silica calcined at 600° C.) to control the desired Al loadings.

An alternative route to form the supported aluminoxane intermediate “in-situ” is adding excess organoaluminum compound on the oxygen source containing support when a trihydrocarbylaluminum compound is used as the organoaluminum compound. The excess organoaluminum compound now serves as both the organoaluminum compound and the trihydrocarbylaluminum compound. The activator composition of this invention is then formed by combining at least a portion of the intermediate composition with the carbocation agent.

Still another alternative route to form the supported aluminoxane intermediate when a trihydrocarbylaluminum compound is used as the organoaluminum compound is adding a high trihydrocarbylaluminum containing aluminoxane to the support. The high trihydrocarbylaluminum containing aluminoxane is made from a low oxygen source content that allows a desired amount of free trihydrocarbylaluminum compound present in the aluminoxane. Then, at least a portion of the intermediate composition with trihydrocarbylaluminum can be combined with the carbocation agent to form the activator composition of this invention.

The combining can be conducted in an inert gas atmosphere at a temperature from about −80° C. to about 200° C., such as from about 0° C. to about 150° C.; and the combining time can be from about 1 minute to about 36 hours, such as from about 10 minutes to about 24 hours. Treatments after completion of the combining operation can include filtration of supernatant, followed by washing with an inert solvent and evaporation of the solvent under reduced pressure or in inert gas flow, but these treatments are not required. Resulting activator compositions can be used for polymerization in any suitable state, including fluid, dry, or semi-dry powder, and may be used for polymerization in the state of being suspended in inert solvent. The combining of the components may be conducted at ambient temperature and at a combining time of from about 15 minutes to about 48 hours, such as from about 15 minutes to about 6 hours; and the resulting combination can be used as is or subsequently heated to a temperature of about 80° C. to about 150° C.

In the supported aluminoxane embodiment, the mole ratio of the carbocation agent compound of formula R¹(X)ₙ to the trihydrocarbylaluminum compound AlR₃ is from about 0.01:1 to 2:1 such as from about 0.1:1 to about 1.5:1 such as from about 0.9;1 to 1.1:1, such as about 1:1; the mole ratio of X to Al for the compound of formula R¹(X)ₙ and the supported aluminoxane is from about 0.01:1 to 0.8:1, such as from about 0.03:1 to 0.5:1, such as about 0.1:1. The Al mole ratio for trihydrocarbylaluminum to supported aluminoxane is from about 0.01:1 to 0.8:1, such as from about 0.03:1 to 0.5:1, such as about 0.1:1. If the aluminoxane is generated in-situ on a support by the reaction of the organoaluminum compound with the oxygen source on the support, e.g., the absorbed or added water on silica, the organoaluminum compound can be charged as the sum of two portions, one portion as the trihydrocarbylaluminum component, a stoichiometric portion for reaction with R¹(X)ₙ described above, plus the other portion as the organoaluminum compound for in-situ formation of the aluminoxane on the support.

In the non-supported solution aluminoxane embodiment, the mole ratio of the carbocation agent compound of formula R¹(X)ₙ to the trihydrocarbylaluminum compound AlR₃ is from about 0.01:1 to 0.1:1, such as from about 0.05:1 to about 0.08:1, such as about 1:1. The mole ratio of X to Al for the compound of formula R¹(X)ₙ and the non-supported solution aluminoxane is from about 0.01:1 to 0.15:1, such as from about 0.03:1 to 0.08:1, such as about 0.04:1. The Al mole ratio for trihydrocarbylaluminum to non-supported solution aluminoxane is from about 0.01:1 to 0.15:1, such as from about 0.03:1 to 0.08:1, such as about 0.04:1.

The amount of aluminum in the activator composition should not be less than about 0.1 mmol, such as not less than about 1 mmol, in 1 g of the solid component in the dry state. Aluminum loading in the final catalyst composition is generally from about 5 wt.% to about 25 wt. %, preferably from about 15 wt. % to about 20 wt. %.

### III. Transition Metal Component

To form the ethylene copolymer, an activator composition as described above and a transition metal component may each be added independently, yet substantially simultaneously, to the monomers to catalyze polymerization. Alternatively, the activator composition and transition metal component may be combined to form a catalyst product and at least a portion of the product may be added to the monomers to catalyze polymerization. The Al:transition metal ratio can be about 1:1 to about 1000:1, such as from about 200:1 to about 300:1.

The transition metal component can comprise any transition metal component having olefin polymerization potential. For example, without limitation, the transition metal component can comprise one or more metallocene transition metal components.

The transition metal component can comprise a catalyst precursor MLₐQ_{q-a}, wherein M represents transition metal atom of the 4th Group or Lanthanide Series of the Periodic Table of Elements (1993, IUPAC), for example, titanium, zirconium, or hafnium and transition metals of the Lanthanide Series, such as samarium; L represents group having cyclopentadienyl structure or group having at least one hetero atom, at least one L being group having a cyclopentadienyl structure, and each L may be the same or different and may be crosslinked to each other; Q represents halide radicals, alkoxide radicals, amide radicals, and hydrocarbyl radicals having 1 to about 20 carbon atoms; “a” represents a numeral satisfying the expression 0<a≤q; and q represents valence of transition metal atom M.

L can comprise, for example, cyclopentadienyl group, substituted cyclopentadienyl group or polycyclic group having cyclopentadienyl structure. Example substituted cyclopentadienyl groups include hydrocarbon groups having 1 to about 20 carbon atoms, halogenated hydrocarbon groups having 1 to about 20 carbon atoms, silyl groups having 1 to about 20 carbon atoms and the like. Silyl groups according to this invention can include SiMe₃ and the like. Examples of polycyclic groups having cyclopentadienyl structure include indenyl groups, fluorenyl groups, and the like. Examples of hetero atoms of the group having at least one hetero atom include nitrogen, oxygen, phosphorous, sulfur, and the like.

Example substituted cyclopentadienyl groups include methylcyclopentadienyl groups, ethylcyclopentadienyl groups, n-propylcyclopentadienyl groups, n-butylcyclopentadienyl groups, isopropylcyclopentadienyl groups, isobutylcyclopentadienyl groups, sec-butylcyclopentadienyl groups, tertbutylcyclopentadienyl groups, 1,2-dimethylcyclopentadienyl groups, 1,3-dimethylcyclopentadienyl groups, 1,2,3-trimethylcyclopentadienyl groups, 1,2,4-trimethylcyclopentadienyl groups, tetramethylcyclopentadienyl groups, pentamethylcyclopentadienyl groups, and the like.

Example polycyclic groups having cyclopentadienyl groups include indenyl groups, 4,5,6, 7-tetrahydroindenyl groups, fluorenyl groups, and the like.

Example groups having at least one hetero atom include methylamino groups, tert-butylamino groups, benzylamino groups, methoxy groups, tert-butoxy groups, phenoxy groups, pyrrolyl groups, thiomethoxy groups, and the like.

One or more groups having cyclopentadienyl structure, or one or more groups having cyclopentadienyl structure and one or more group having at least one hetero atom, may be crosslinked with (i) alkylene groups such as ethylene, propylene, and the like; (ii) substituted alkylene groups such as isopropylidene, diphenylmethlylene, and the like; or (iii) silylene groups or substituted silylene groups such as dimethylsilylene groups, diphenylsilylene groups, methylsilylsilylene groups, and the like.

Q comprises halide radicals, alkoxide radicals, amide radicals, hydrogen radical, or hydrocarbyl radicals having 1 to about 20 carbon atoms. Examples of Q include Cl, F, Br, MeO, EtO, PhO, C6F5O, BHT, Me2N, Et2N, Ph2N, (Me3Si)2N, alkyl groups having 1 to about 20 carbon atoms such as methyl groups, ethyl groups, n-propyl groups, isopropyl groups, n-butyl groups, benzyl groups, silyl groups such as Me3Si, Ph3Si, and the like.

Examples of transition metal component MLₐQ_{q-a}, wherein M comprises zirconium include bis(cyclopentadienyl)zirconium dichloride, bis(methylcyclopentadienyl)zirconium dichloride, bis(pentamethylcyclopentadienyl)zirconiumdimethyl, bis(indenyl)zirconium dichloride, bis(4,5,6, 7-tetrahydroindenyl)zirconium dichloride, bis(fluorenyl)zirconium dichloride, ethylenebis(indenyl)zirconium dichloride, dimethylsilylene(cyclopentadienylfluorenyl)zirconium dichloride, diphenylsilylenebis(indenyl)zirconium dichloride, cyclopentadienyldimethylaminozirconium dichloride, cyclopentadienylphenoxyzirconium dichloride, dimethyl(tert-butylamino)(tetramethylcyclopentadienyl) silanezirconium dichloride, isopropylidene(cyclopentadienyl)(3-tert-butyl-5-methyl-2-phenoxy)zirconium dichloride, dimethylsilylene(tetramethylcyclopentadienyl)(3-tertbutyl-5-methyl-2-phenoxy) zirconium dichloride, bis(cyclopentadienyl)zirconiumdimethyl, bis(methylcyclopentadienyl)zirconiumdimethyl, bis(pentamethylcyclopentadienyl)zirconiumdimethyl, bis(indenyl)zirconiumdimethyl, bis(4,5,6, 7-tetrahydroindenyl)zirconiumdimethyl, bis(fluorenyl)zirconiumdimethyl, ethylenebis(indenyl)zirconiumdimethyl, dimethylsilylene(cyclopentadienylfluorenyl)zirconiumdimethyl, diphenylsilylenebis(indenyl)zirconiumdimethyl, cyclopentadienyldimethylaminozirconiumdimethyl, cyclopentadienylphenoxyzirconium dimethyl, dimethyl(tert-butylamino)(tetramethylcyclopentadienyl) silanezirconiumdimethyl, isopropylidene(cyclopentadienyl)(3-tert-butyl-5-methyl-2-phenoxy)zirconiumdimethyl, dimethylsilylene(tetramethylcyclopentadienyl)(3-tertbutyl-5-methyl-2-phenoxy) zirconiumdimethyl and the like.

Additional exemplary transition metal components MLₐQ_{q-a} include components wherein zirconium is replaced with titanium or hafnium in the above zirconium components.

Additional exemplary transition metal components MLₐQ_{q-a} include components wherein Q can be the same or different in one molecule.

Other catalyst precursors useful in this invention are: rac-dimethylsilylbis(2-methyl-4-phenyl-indenyl)zirconium dimethyl (M1); rac-dimethylsilylbis(2-methyl-4-phenyl-indenyl)zirconium dichloride; rac-dimethylsilylbis(2-methyl-1-indenyl) zirconium dimethyl; rac-dimethylsilylbis(2-methyl-4,5-benzoindenyl) zirconium dimethyl; rac-ethylenebis(tetrahydroindenyl)zirconium dimethyl; rac-ethylenebis-(tetrahydroindenyl)zirconium dichloride; and rac-ethylenebis(indenyl) zirconium dimethyl, bis(1-butyl-3-methylcyclopentadienyl) zirconium dimethyl, bis(1-butyl-3-methylcyclopentadienyl) zirconium dichloride. Bis(1-butyl-3-methylcyclopentadienyl) zirconium dichloride is preferred.

The polymerization method is not limited, and both liquid phase polymerization and gas phase polymerization can be used. Examples of solvents used for liquid phase polymerization include aliphatic hydrocarbons such as butane, isobutane, pentane, heptane, octane and the like; aromatic hydrocarbons such as benzene, toluene and the like; and hydrocarbon halides such as methylene chloride and the like. It is also possible to use at least a portion of the olefin to be polymerized as a solvent. The polymerization can be conducted in a batch-wise, semibatch-wise or continuous manner, and polymerization may be conducted in two or more stages which differ in reaction conditions. The polymerization temperature can be from about −50° C. to about 200° C., such as from 0° C. to about 100° C. The polymerization pressure can be from atmospheric pressure to about 100 kg/cm², such as from atmospheric pressure to about 50 kg/cm². Appropriate polymerization time can be determined by means known to those skilled in the art according to the desired olefin polymer and reaction apparatus and is typically within the range from about 1 minute to about 20 hours. In the present invention, a chain transfer agent such as hydrogen may be added to adjust the molecular weight of olefin polymer to be obtained in polymerization. Preferably, the polyethylene copolymer is formed using only one catalyst species comprising a metallocene component and one of the activator compositions described above. Additionally, the copolymer is preferably formed in a single reactor. The ability to form a copolymer having a broad short-chain branching distribution with only one catalyst species and in only one reactor is a significant advantage over prior attempts to form polymers with a broad short-chain branching distribution.

### 3) Films

The present disclosure also relates to films formed from the polyethylene copolymer. The films have a desirable blend of properties attributable to the molecular structure of the copolymer. For example, films formed from the polyethylene copolymer generally exhibit improved hot seal initiation temperature, hot tack initiation temperature, Elmendorf tear strength, and dart impact strength. They also exhibit good tensile strength, elongation at break, and low haze. The films may be formed from the copolymer alone or in combination with other polymers. For example, in one embodiment, a film is formed from a composition containing the polyethylene copolymer described herein and low-density polyethylene. The polyethylene copolymer described herein generally constitutes at least about 50% of the film, such as at least about 70% of the film, such as at least about 85% of the film.

The term “film” is a sheet, laminate, web or the like or combinations thereof, having length and breadth dimensions and having two major surfaces with a thickness therebetween. A film can be a monolayer film (having only one layer) or a multilayer film (having two or more layers). In an embodiment, the film is a monolayer film with a thickness from about 12 μm to about 250 μm, such as from about 20 μm to about 50 μm.

The term “multilayer film” is a film having two or more layers. Layers of a multilayer film are bonded together by one or more of the following nonlimiting methods: coextrusion, extrusion coating, vapor deposition coating, solvent coating, emulsion coating, suspension coating, or adhesive lamination. In an embodiment, the multilayer film has a thickness from about 12 μm to about 250 μm, such as from about 20 μm to about 50 μm.

The film may be an extruded film. Extrusion a process for forming continuous shapes by forcing a molten plastic material through a die, optionally followed by cooling or chemical hardening. Immediately prior to extrusion through the die, the relatively high-viscosity polymeric material is fed into a rotating screw, which forces it through the die. The extruder can be a single screw extruder, a multiple screw extruder, a disk extruder or a ram extruder. The die can be a film die, blown film die, or sheet die.

The film may be a coextruded film. The terms “coextrusion,” and “coextrude,” is/are a process for extruding two or more materials through a single die with two or more orifices arranged so that the extrudates merge or otherwise weld together into a laminar structure. Coextrusion may be employed as an aspect of other processes, for instance, in film blowing, casting film, and extrusion coating processes.

The film may be a blown film. The terms “blown film” or “film blowing” is/are a process for making a film in which a polymer or copolymer is extruded to form a bubble filled with air or another gas in order to stretch the polymeric film. Then, the bubble is collapsed and collected in flat film form.

Films formed from the copolymer described herein generally exhibit a dart impact strength of from about 800 gf to about 1500 gf, such as form about 900 gf to about 1300 gf, such as from about 1100 gf to about 1200 gf, as determined according to ASTM D1709 at a thickness of 1.6 mil (40.6 μm).

Additionally, films formed from the copolymer described herein generally exhibit an Elmendorf tear strength in the machine direction of from about 450 to about 700, such as from about 500 to about 600, such as form about 525 to about 575, as determined according to ASTM D1922 at a thickness of 1.6 mil (40.6 μm). Films formed from the copolymer described herein generally exhibit an Elmendorf tear strength in the transverse direction of from about 600 to about 800, such as from about 650 to about 700, as determined according to ASTM D1922 at a thickness of 1.6 mil (40.6 μm).

Films formed from the copolymer described herein also exhibit good optical properties. For example, the films generally have gloss values from about 40 to about 60, such as from about 45 to about 55 as determined according to ASTM D2457 at a 45° angle at a thickness of 1.6 mil (40.6 μm). Additionally, films formed from the copolymer described herein generally have haze values from about 5% to about 15%, such as from about 8% to about 13%, such as from about 10% to about 12% as determined according to ASTM D1003 at a thickness of 1.6 mil (40.6 μm).

The present invention, thus generally described, will be understood more readily by reference to the following examples, which are provided by way of illustration and are not intended to be limiting of the present invention.

### EXAMPLES

### Test Methods

### Crystallization Elution Fractionation

Samples were prepared by dissolving about 15 mg of sample in ODBC (o-dichlorobenzene) at 160° C. for 1 hour.

### Analysis Conditions

| Analysis Method | CEF 2-4-1 Col Vol 0.6 | |
|---|---|---|
| Stabilization | 110° | C. |
| Temperature | | |
| Crystallization Rate | 2° C./min | |
| Crystallization | 35° | C. |
| Temperature | | |
| SF Time | 5 | min |
| Elution Rate | 4° C./min | |
| Elution Temperature | 140° | C. |
| Crystallization Pump | 0.05 | mL/min |
| Flow | | |
| Elution Pump Flow | 1 | mL/min |

### Successive Self Nucleation Annealing

About 5 mg PE sample is first heated up to 200° C. to remove all thermal history, followed by a series of cooling/heating cycles. The temperature for the cooling cycle is always set at 20° C. while the set temperature for the heating cycle varies from 128° C. to 73° C. at 5° C. intervals with a total of 12 self-nucleation and annealing steps. After cooling down to 73° C., the sample is heated up to 170° C. and the final melting curve is used for SSA data analysis. Heating/cooling rate is 10° C./min for all cycles. To compare with CEF, the temperatures of SSA curves are modified by subtracting 32° C. and the modified curve is defined as m-SSA.

All operations were performed under inert atmosphere of dry nitrogen using drybox or Schlenk line techniques. Solvents were dried/stored over molecular sieves.

### Catalyst Activity

Catalyst activity is determined by dividing the amount of polymer made by the amount of catalyst added and normalized to 60 minutes.

Density was determined according to ASTM D1505.

Melt index was determined according to ASTM D1238 under 2.16 kg and at 190° C.

Dart drop impact strength was measured according to ASTM D1709.

Haze was measured according to ASTM D1003.

Gloss was measured according to ASTM D2457 at a 45° angle.

Elmendorf tear resistance was measured according to ASTM D1922.

### Example 1—Catalyst Preparation

A supported activator composition was prepared as described in U.S. Pat. Nos. 8,354,485 and 9,090,720. The activator was subsequently mixed with bis(1-butyl-3-methylcyclopentadienyl)zirconium dichloride metallocene in a hydrocarbon solvent for several hours. The resulting mixture was filtered. The solids collected were washed with fresh hydrocarbon solvent and dried under vacuum. Zr loading in the final catalyst was 0.35-1.0 wt. % and residual solvent content was less than 3 wt. %. Al content in the final catalyst was 15-20 wt. %.

### Example 2—Polymerization (Autoclave)

A clean and purged (inert gas) jacketed autoclave reactor is subsequently charged with specified amounts of isobutane, hexene, hydrogen, scavenger, and antistatic agent under inert conditions. The reactor pressure and temperature are monitored. The autoclave is heated to a specified temperature and stirred at about 800 RPM using a marine impeller. Once the desired temperature is reached (usually about 5 minutes) the desired amount of ethylene pressure is added. The desired amount of catalyst prepared in the manner of Example 1 is added once the ethylene pressure has neared the desired set point. Once the catalyst is added, the polymerization time is started. Ethylene pressure (feed) is maintained constant throughout the duration of the polymerization test via a mass flow controller. Once the polymerization time is over, the volatile contents are flashed and the temperature/pressure of the autoclave are reduced to atmospheric conditions (usually about 5 minutes). The autoclave is then opened. The polymer formed is collected, dried under vacuum at about 70-80° C. until constant weight. After the polymer is removed, the autoclave is cleaned of any residual polymer, closed and subjected to an automated heat/inert-gas purging sequence to prepare reactor for the next polymerization test.

### Example 3—Polymerization (Gas Phase—Bench Scale)

A 5 L Xytel reactor fitted with suitable software capable to control the reactor is heated to above 100° C. and purged with dry N₂ multiple times. The reactor is charged with dry NaCl (typically 500-1000 grams) and continuous purged with dry N₂ while stirring at above 100° C. for 15-20 minutes. The pressure is maintained at about 50 psi during the purge. The reactor is cooled to about 80-85° C. Silica-MAO solids (8 grams) are added via charge bomb using N₂ pressure. The reactor is stirred for 25-30 minutes with 40-50 psi N₂ pressure on reactor. The pressure is slowly reduced to about 3 psi. The desired gas combination of N₂, H₂, and ethylene are added so the pressure is close to the desired 225 psi setpoint for polymerization and a valve allowing for hexene flow is opened. The hexene/ethylene and H₂/ethylene ratios are monitored by on-line GC analysis. H₂, ethylene, and hexene are fed on demand to target the desired ratios needed for the specific polymerization experiment. The desired amount of catalyst prepared in the manner of Example 1 is loaded into a charge bomb along with silica-MAO solids (2 grams) and injected into the reactor while stirring. Once the internal temperature stabilizes and reaches the desired setpoint the reaction is run for 1 hour. At the end of the polymerization the reactor is cooled and vented to about 20° C. and thoroughly purged with low N₂flow to remove residual hydrocarbon. The reactor contents are isolated in air and the salt removed via water washing/filtration steps. The polymer is dried until constant weight and further analyzed as needed.

### Examples 4—Polymerization (Gas Phase—Continuous)

A hexene-ethylene copolymer was produced in a continuous fluidized gas phase polymerization reactor in the presence of hydrogen. The desired resin target was a polymer with a melt index of about 1.0 g/10 min. and a density of about 0.918 g/cc. Reactor temperature was maintained in the range of about 75-85° C. Catalyst prepared as described in Example 1 was fed on continuous basis to the reactor to maintain the desired polymer production rate. Product was removed on a continuous basis to maintain desired fluidized bed height. The characteristics of the resulting polymer are shown in Table 1. Table 1 also lists the same characteristics for Exceed 1018, an ethylene 1-hexene copolymer commercially available from ExxonMobil. Additionally, the CEF profile of the resulting polymer is shown in FIG. 1 and the cumulative CEF and m-SSA profiles are shown overlayed in FIG. 2.

TABLE 1

| | | Exceed 1018 |
|---|---|---|
| Property | Example 4 | (comparative) |
| Density [g/cc] | 0.918 | 0.918 |
| MI [g/10 min] | 1 | 1 |
| CEF delta T [° C.] | 30.7 | 25.2 |
| F, [%] | 11.4 | 5.7 |
| S—C at 70° C. [%] | 13.6 | 19.1 |
| Zr residue in pellet [ppm] | 0.31 | 0.53 |

### Example 5—Film Forming

Blown films were produced under the following process conditions:
a. 3″ die and 100 mil die gap
b. Dual lip air ring
c. 1.5″ extruder with straight compression screw
d. Gravimetric blender was used to blend in LDPE at 10%
e. The film samples were run as 35 lbs/hr and with the same heat profile for extruder and die
f. The line speed was varied to get two different thicknesses: 1 mil and 1.6 mil
g. All samples run as tubing with a target of 12″ LF and 9″ FLH, air ring temperature and blower speeds were comparable during the run.

Films were made under the above conditions using the polymer produced in Example 4 and using Exceed 1018. Properties of the resulting films are listed in Table 2.

TABLE 2

| | | Exceed 1018 |
|---|---|---|
| Blown Film Property | Example 6 | (comparative) |
| Density [g/cc] | 0.918 | 0.918 |
| Melt Index [g/10 min] | 1 | 1 |
| Thickness [mils] | 1.6 | 1.6 |
| Dart drop f-50 (gf) | 1162 | 724 |
| Haze % | 11.8 | 12.9 |
| 45° Gloss (outside of the | 49.7 | 49.8 |
| bubble) | | |
| Elmendorf tear Machine | 558 | 443 |
| Direction (grams) | | |
| Elmendorf tear Transverse | 685 | 603 |
| Direction (grams) | | |

While certain embodiments have been illustrated and described, it should be understood that changes and modifications may be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations may be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like, include the number recited and refer to ranges which may be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A polyethylene comprising ethylene units and α-olefin comonomer units, the polyethylene having the following characteristics:
a melt index from about 0.1 to about 15 g/10 min as determined by ASTM D1238 under 2.16 kg and at 190° C.;
a density from 0.905 to 0.930 g/cc as determined by ASTM D1505;
a molecular weight distribution (Mw/Mn) from about 1.5 to about 2.7;
a Crystallization Elution Fractionation temperature range excluding the first 10% and the last 1% polymer on the temperature scale following the equation: ΔT[° C.]≥−909*density[g/cc]+863; and
a lamellar thickness distribution following the equation: F %≥510*(density[g/cc]−0.905), where F % is the percentage of lamellar thickness greater than 12 nm.

2. The polyethylene of claim 1, wherein the cumulative fraction difference (S−C) between modified SSA and CEF at 70° C. is less than 15%.

3. The polyethylene of claim 1, wherein the polyethylene has a density from 0.905 to 0.925 g/cc.

4. The polyethylene of claim 1, wherein the polyethylene has a melt index from about 0.5 to about 5 g/10 min as determined by ASTM D1238 under 2.16 kg and at 190° C.

5. The polyethylene of claim 1, wherein the α-olefin comonomer comprises hexene.

6. The polyethylene of claim 1, wherein the percentage of lamellar thickness greater than 12 nm (F %) is greater than 10%.

7. (canceled)

8. A film comprising the polyethylene of claim 1.

9. A pellet containing the polyethylene of claim 1, wherein the pellet contains Zr in an amount less than 0.50 ppm.

10. (canceled)

11. (canceled)

12. A polyethylene comprising ethylene units and α-olefin comonomer units, the copolymer having the following characteristics:
a melt index from about 0.1 to about 15 g/10 min as determined by ASTM D1238 under 2.16 kg and at 190° C.;
a density from 0.905 to 0.935 g/cc as determined by ASTM D1505;
a molecular weight distribution (Mw/Mn) from about 1.5 to about 2.7;
a Crystallization Elution Fractionation temperature range excluding the first 10% and the last 1% polymer on the temperature scale following the equation: CEF ΔT[° C.]≥−909*(density[g/cc])+863; and
a lamellar thickness distribution following the equation: F %≥510*(density[g/cc]−0.905), where F % is the percentage of lamellar thickness greater than 12 nm;
wherein the polyethylene is polymerized in the presence of a catalyst composition comprising:
an intermediate composition derived from at least a support, an organoaluminum compound, and an oxygen source;
either (A) R²₂AlY, wherein each R² independently comprises a hydrocarbyl group having from 1 to about 20 carbons, and Y comprises a halide radical, a pseudo halide radical, an alkoxide radical, an aryloxide radical, an alkyl substituted amide radical, an aryl substituted amide radical, a siloxy radical, a boronoxy radical, a diaryl boronoxy radical, or a halogenated diaryl boronoxy radical, or (B) a combination of (i) and (ii) wherein (i) is a compound having the formula R¹(X)ₙ; wherein R¹ is a hydrocarbyl group having from about 1 to about 20 carbon atoms; n is from 1 to the number of possible substitutions of the hydrocarbyl group and each X is optionally substituted on R¹ and is independently halogen, —OSi(R³)₃, —N(Si(R³)₃)₂, —N(R³)₂;—SR³;—P(R³)₂; —CN, or —OR⁴; wherein each R³ is independently hydrogen or a hydrocarbyl group having from about 1 to about 20 carbon atoms; each R⁴ is independently a hydrocarbyl having from 1 to 20 carbon atoms, wherein when at least one R³ is a hydrocarbyl group, R¹ and R³ or R¹ and R⁴ are optionally linked together to form a cyclic group; provided that at least one X is not directly bonded to an aryl group; and provided that when X is not halogen, X is bonded to a secondary or tertiary carbon, or a —CH₂-aryl group; and (ii) is a trihydrocarbylaluminum compound having the formula AlR₃, wherein each R is independently a C₁-C₂₀ hydrocarbyl group; and
a transition metal component.

13. The polyethylene of claim 12, wherein the transition metal component comprises a metallocene component.

14. The polyethylene of claim 13, wherein the metallocene component comprises bis(1-butyl-3-methylcyclopentadienyl)zirconium dichloride.

15. The polyethylene of claim 12, wherein the cumulative fraction difference (S−C) between M-SSA and CEF at 70° C. is less than 15%.

16. The polyethylene of claim 12, wherein the polyethylene has a density from 0.905 to 0.925 g/cc.

17. The polyethylene of claim 12, wherein the polyethylene has a melt index from about 0.5 to about 5 g/10 min as determined by ASTM D1238 under 2.16 kg and at 190° C.

18. The polyethylene of claim 12, wherein the α-olefin comonomer comprises hexene.

19. The polyethylene of claim 12, wherein the percentage of lamellar thickness greater than 12 nm (F %) is greater than 10%.

20. (canceled)

21. A film comprising the polyethylene of claim 12.

22. A pellet containing the polyethylene of claim 12, wherein the pellet contains Zr in an amount less than 0.50 ppm.

23. (canceled)

24. (canceled)

25. The polyethylene of claim 12, wherein the polyethylene is produced in a single reactor.

26. The polyethylene of claim 12, wherein the polyethylene is produced using a single catalyst species.
